(19) United States
(12) Patent Application Publication
(10) Pub. No.: US 2013/0187425 A1
(43) Pub. Date: Jul. 25, 2013

(54) ADJUSTING DEVICE FOR ADJUSTING A MOTOR VEHICLE SEAT, MOTOR VEHICLE SEAT, MOTOR VEHICLE AND METHOD FOR ADJUSTING A MOTOR VEHICLE SEAT

(71) Applicant: GM Global Technology Operations LLC, Detroit, MI (US)

(72) Inventor: Andrzej PLESKOT, Trebur (DE)

(73) Assignee: GM Global Technology Operations LLC, Detroit, MI (US)

(21) Appl. No.: 13/746,065

(22) Filed: Jan. 21, 2013

(30) Foreign Application Priority Data
Jan. 25, 2012 (DE) 102012001279.9

(51) Int. Cl. B60N 2/22; B60N 2/02

(52) U.S. Cl. CPC B60N 2/22; B60N 2/02
USPC 297/353; 297/463.1

(57) ABSTRACT

An adjusting device for adjusting a motor vehicle seat is provided. The adjusting device includes a locking device with a step-up transmission unit, a pulling force element configured for actuation and coupled to the step-up transmission unit and a resetting device configured to reset the step-up transmission unit into a starting state. The resetting device is at least partially integrated in the pulling force element. A motor vehicle seat, a motor vehicle, and a method for adjusting a motor vehicle seat using the adjusting device are also provided.

### CROSS-REFERENCE TO RELATED APPLICATION

This application claims priority to German Patent Application No. 10 2012 001 279.9, filed Jan. 25, 2012, which is incorporated herein by reference in its entirety.

### TECHNICAL FIELD

The technical field relates to an adjusting device for adjusting a motor vehicle seat, a vehicle seat including the adjusting device, a motor vehicle including the vehicle seat and a method for adjusting a motor vehicle seat using the adjusting device.

### BACKGROUND

From the prior art, motor vehicles with seats are known, with which the position of the backrest, in particular with respect to a seat part, is adjustable. The adjustment is effected via a lever mechanism arranged on the seat or another actuating device fixed there. Here, stepless adjustments by means of actuators and discontinuous adjustment, i.e. step-by-step adjustment by means of mechanical solutions are known. With the mechanical adjustments, a locking or arresting device of the adjusting device has to be released for adjusting and locked for arresting. This is carried out via a lever, via which a force is transmitted to an engagement fitting. Here, a force transmission takes place proportionally, i.e. a force to be transmitted increases with the lever travel or in the case of a rotary movement, the torque increases with the twisting angle. Because of intermediate positions of the engagement fittings, adjusting is possible even with the engagement fitting not fully unlocked. In the case of adjusting in intermediate positions, undesirable side effects such as noise development occur during adjusting or increased wear.

From DE 38 00 924 C2 a vehicle seat having an adjusting device for the backrest is known. The adjusting device consists of a fixed-location bearing pedestal, a pivot arm pivotably mounted on the bearing pedestal, which is fastened to the backrest and can be fixed in selectable angular positions by means of a locking device. The adjusting device in the direction of the seat user is covered by a covering part, characterized in that the bearing pedestal is fastened to the seat part and the remaining parts of the adjusting device are arranged within the backrest and connected to the latter. The covering part is connected to a part of the adjusting device in a fixed manner and comprises a slit into which a region of the bearing pedestal projecting upwards dips when the backrest is folded forward. For an operating comfort of the adjusting device, an actuating unit is provided, which is set back into a starting position by means of its resetting mechanism.

The resetting mechanism includes additional components such as springs and the like, which require elaborate assembly. In addition, a play is present in the known devices, which disadvantageously influences an operating comfort.

It is therefore at least one object herein to provide a solution which ensures a simpler and more comfortable resetting possibility. It is at least one object herein, in particular, to provide a motor vehicle, a motor vehicle seat, an adjusting device and a method thereto, with which the resetting mechanism is improved and a play is reduced. In addition, other objects, desirable features and characteristics will become apparent from the subsequent summary and detailed description, and the appended claims, taken in conjunction with the accompanying drawings and this background.

### SUMMARY

In an exemplary embodiment, an adjusting device for adjusting a motor vehicle seat is provided. The discontinuous adjusting device for adjusting a backrest position of the motor vehicle seat includes a locking device that includes at least one step-up transmission unit, which is coupled for actuation with at least one pulling force element and a resetting device, which resets the step-up transmission unit into a starting state. The resetting device is at least partially integrated in the pulling force element. Adjusting of a backrest is effected by exerting force on the backrest. In an embodiment, the backrest is preloaded, so that a preload force acts in a direction of an upright seat position and against a position that is pivoted back. In order to pivot the backrest or a backrest part, a force is preferably exerted by a user seated on the seat, preferably by a leaning against the backrest. To prevent an unintentional adjustment of the backrest, the adjusting device has a blocking device or arresting device which prevents the unintentional adjusting. The arresting device is preferably designed as an engagement fitting unit, with which two engagement fitting parts act together. These are unlocked for adjusting, so that a seat adjustment can take place. The adjusting device includes the engagement fitting unit. When locked, the two engagement fitting parts are engaged, for example by teeth. In order to make possible an adjusting, the engagement fitting parts are moved apart, so that they are no longer engaged. In an embodiment, the force required for this or the movement for this is transmitted via a force transmission device. During the relative movement of the two engagement fitting parts there are different intermediate positions between the two end positions or end states—locking and releasing—during the moving apart. With some of these intermediate positions, adjusting is possible although the engagement fitting parts are still slightly engaged. In order to move the engagement fitting parts apart, the force transmission device is provided, with which a force for locking and unlocking can be transmitted at least to the engagement fitting unit. The force in this case correspondingly results in a relative movement of the engagement fitting parts. In order to employ a force, which is transmitted to the engagement fitting unit via the force transmission device, so that adjusting only takes place upon a complete moving-apart of the engagement fitting parts, a force step-up transmission device is provided. The force transmission device is designed to perform the state in which the engagement fitting parts are completely apart from each other and adjusting is to be carried out without contact of the engagement fitting parts, which in a decoupling point, i.e. a point or state in which the engagement fitting parts are completely no longer engaged, noticeably less force is to be exerted on the force transmission device, i.e. a corresponding feedback to the operator is provided. Here, the adjusting device is designed so that the force transmission device becomes easier to operate when the decoupling point or a decoupling state has been reached. In an embodiment, a force transmission device is provided. In other embodiments, a plurality of force transmission devices is provided, for example two, three or more. The plurality of force transmission devices are coupled in an embodiment, for example connected in series or in parallel. A further embodiment provides a force step-up transmission device. Another embodiment provides a plurality of force step-up transmission devices. The plurality of force step-up transmission devices in an embodiment is coupled, for example connected in series or in parallel. In an embodiment, the force transmission device is designed as lever, gearing or the like, i.e. the force transmission device comprises a step-up section with which a force is stepped up. However, the force is stepped up independently of an angle or a distance of the force transmission device, so that a predetermined step-up ratio is present at all times. The force step-up transmission device provides an additional step-up transmission. In particular, the force step-up transmission device is designed in such a manner that different step-up ratios can be realised. To this end, the force step-up transmission device can be varied relative to the force transmission device, in particular moved, for example moved translatorically and/or rotatorically.

In another embodiment, in order to operate or actuate the adjusting device, an operating unit is provided. In an embodiment, the operating unit comprises a step-up unit, which is designed for example as rotary lever. In another embodiment, the step-up unit is designed as a driver on which an operating lever is seated. The step-up transmission unit is preferably arranged on a rotation axis of the adjusting device in order to move the seat part and the backrest part about these, so as to bring about an unlocking of the adjusting device or of the locking device. Correspondingly, the operating unit is coupled to the step-up transmission unit. In order for the locking device not to remain in an unlocked state but is always returned into a blocking or locking state, a resetting mechanism or a resetting device is provided. According to an embodiment, the resetting device is designed at least partially integrated in the pulling force element. The pulling force element connects two lateral locking devices of the adjusting device which are spaced from each other. Preferably, the pulling force element is designed as a cable-like element, which is substantially designed for the pulling force transmission. A compressive force is not or not substantially or negligibly transmitted.

The adjusting device for adjusting a motor vehicle seat, in particular a discontinuous adjusting device for adjusting a backrest position of the motor vehicle seat or a backrest part relative to a seat part of the motor vehicle seat comprises at least two locking devices, which can be actuated via at least one actuating device. Here, the locking devices can be connected in series with the operating unit.

The motor vehicle seat comprises a backrest or a backrest part and a seat part. The backrest part and the seat part are adjustably interconnected via an adjusting device. In an embodiment, the adjusting device comprises a rotation axis about which the backrest part can be pivoted or folded relative to the seat part so that an angle between seat part and backrest part can be adjusted as required by the user. In order to arrest the backrest part in a desired position, the adjusting device comprises at least one locking device. Preferably, a locking device each is provided on each side of the motor vehicle seat or of the adjusting device.

Preferably, the adjusting device comprises two locking devices, one on each side of the motor vehicle seat. The locking devices each comprise a separate locking mechanism. In order for the locking devices to unlock the adjusting device synchronously, these are connected or coupled to one another. The connection in an embodiment is parallel. Preferably, the locking devices are connected in series. Furthermore, a corresponding synchronisation is required for the synchronous opening of the locking devices. Coupling the two locking devices is preferably carried out via a pulling force element, in particular by a control cable.

In an embodiment, each locking device comprises a lever unit, via which the locking device can be actuated and/or a force to be transmitted can be stepped up. The lever unit is arranged in a rotationally fixed manner on a rotation axis of the locking device. Upon an actuation, i.e. a rotation of the lever unit, the rotation axis is co-rotated and the locking device unblocked, so that the backrest or the backrest part can be adjusted. The lever unit preferably acts as force step-up unit and/or as force transmission unit.

In a further embodiment, the lever units on different blocking devices are configured differently to each other, so that each locking device has a different locking characteristic. In order for the individual locking devices, which are connected in series, to open synchronously, the individual lever units are configured differently. In particular, the lever units comprise different lever arms.

For resetting the step-up unit embodied as lever unit, the resetting mechanism is provided. The latter is at least partially integrated in the pulling force element designed as control cable.

Correspondingly, an embodiment provides that the pulling force element at least partially includes a portion that is elastic in a pulling direction. Via this elastic portion, a resetting function can be realised.

In a further embodiment, the elastic portion is designed as elastic material, for example as spring steel. Correspondingly, the control cable includes the elastic spring steel, with which a resetting function can be realised. Because of the resilient properties alone, a resetting function is realised through the control cable.

In a further embodiment, the resetting device furthermore comprise a deflection part in a connecting region of the pulling force element with the step-up transmission device, along which the pulling force element runs at least partially. The pulling force element is connected to the step-up transmission device for force transmission and/or force step-up transmission. The step-up transmission device is configured as a rotary lever. For resetting the rotary lever, the latter has a deflection part along which the control cable or its elastic portion runs. The deflection part is for example configured as a curved or bent lever arm. Accordingly, the control cable is partially wound about the deflection part. When turning the rotary lever, the control cable, more precisely the elastic portion, is thus loaded, upon which the control cable is elastically deformed. If a force for turning the step-up transmission device is cancelled, the control cable compresses its elastic portion back into its unstretched starting situation. During this, the step-up transmission unit is co-rotated back, so that a resetting is realised. Through the deflection part, a corresponding force step-up transmission is ensured which makes possible a resetting. Here, the control cable at least in certain regions bears against a surface of the deflection part. Because of a frictional force on a contact region with the surface, a corresponding torque is brought about which supports a resetting.

Accordingly, in an embodiment, the step-up transmission device is configured as a rotary lever which is rotatable about a rotation axis. The rotary lever comprises a central part, with which the rotary lever is seated in a rotationally fixed manner on the rotation axis of the respective locking device, if required with a certain play in circumferential direction. A turning of the rotary lever thus causes a turning of the rotation axis and thus an actuation of the locking device. The rotary lever preferably comprises at least one lever arm, preferably two and/or a plurality of lever arms. In an embodiment, the lever arms are configured the same. In other embodiments, the lever arms are embodied differently.

In an embodiment, an operating unit is provided, which is arranged spaced from the step-up transmission device. For actuating the adjusting device and thus the plurality, in particular two locking devices, a single operating unit is provided. This operating unit is coupled to at least one step-up transmission device. Preferably, the operating unit is coupled to exactly one of the plurality of step-up transmission units. Coupling is preferably effected by a pulling force element, for example by a control cable. In this way, the operating unit can be arranged distant from the step-up transmission device. The control cable in this case acts as force transmission device. The force step-up transmission is effected via lever arms on the step-up transmission unit and/or the operating unit. In an embodiment, the control cable comprises at least one elastic portion, for example at least one portion of an elastic material, for example of spring steel. In this way, the operating unit is elastically coupled to the step-up transmission device or step-up transmission unit.

An embodiment provides that the operating unit is configured as a rotary lever that is rotatable about a rotation axis. In this way a step-up transmission function is integrated in the operating unit. Accordingly, the step-up transmission is effected in the form of a lever arm or a plurality of lever arms of the rotary lever. The rotary lever is preferably arranged about a rotation axis spaced from the rotation axis of the locking device. In an embodiment, the operating unit or actuating unit is designed as an actuating lever, which sits on a driver designed as rotary lever. The driver comprises a corresponding mounting for the actuating or operating lever.

In an embodiment, a connecting point of the pulling force element with the step-up transmission device is configured spaced from the rotation axis at an end of the deflection part, so that a torque results at the contact point of pulling force element and deflection part. The pulling force element designed as control cable, which couples the two adjacent and spaced locking devices, is fastened with an end or with a connecting point each to the step-up transmission device. Here, the control cable is connected to the step-up transmission device spaced from the rotation axis, on which the step-up transmission device is arranged. In this way, a torque about the rotation axis can be exerted. The spacing from the rotation axis is adjustable, for example via the shape of the lever arms, on which the pulling force element is arranged in an embodiment. In an embodiment, the pulling force element is configured at an end of the deflection device, so that the pulling force element hugs the deflection device. Through the offset arrangement to the rotation axis and the at least partial wrapping about the deflection part, a torque for rotating the step-up transmission device can be realised. In an embodiment, at least one of the rotary levers or one of the lever devices or more generally one of the step-up transmission devices or operating units is seated on the respective rotation axis in a play-effected manner with a played, in particular with a play in a circumferential direction. In an embodiment, the step-up transmission device sits on the corresponding rotation axis with a play. To this end, the step-up transmission device comprises mouldings and/or recesses formed for this purpose in a circumferential direction and/or in a radial direction, for example in the form of grooves and/or teeth. With these, the step-up transmission device engages in suitably corresponding mouldings and/or recesses, for example corresponding teeth and/or grooves in the rotation axis or on components connected to the latter, so that a type of play-affected tooth connection between operating unit and rotation axis is realised. Here, the mouldings and/or recesses of the operating unit are larger at least in one circumferential direction than the mouldings and/or recesses of the rotation axis or the components for receiving the step-up transmission device connected therewith. In particular, the operating unit and the step-up transmission device include a rotary lever, with which these are each arranged on the corresponding rotation axis. In this respect, at least one of the rotary levers, in particular all rotary levers, have a play, in particular a circumferential play with respect to the rotation axis. Thus, a torque transmission via or to the pulling force element is effected in a delayed manner.

In an embodiment, when the operating unit is actuated, i.e. rotated, the operating unit first moves relative to the corresponding rotation axis until the play is overcome. The pulling force element, which is slack at the start of the movement, is tautened and if required elastically stretched during the overcoming of the play. Without play, the force takes place immediately and the elastic portion is stretched. Following the overcoming of the play, the torque is transmitted to the step-up transmission device via the tautened pulling force element. Here, the play of the step-up transmission device to the corresponding rotation axis is overcome first, if present. Here, the pulling force element, which was previously arranged loose or slack between the two step-up transmission devices of the two locking devices is tautened, tensioned or elastically elongated. Having overcome the play, the stepped-up torque of the step-up transmission device is transmitted to the adjacent step-up transmission device via the pulling force element.

Accordingly, in an embodiment, on the rotary lever of the step-up transmission device two pulling force elements acting in different rotary directions are arranged. One pulling force element acts in a first rotary direction for the force transmission to the operating unit. Another pulling force element acts in the direction opposite to the force coupling with the adjacent step-up transmission device. In this way, a simple resetting by means of pulling force elements is ensured.

Yet a further embodiment provides that the play of at least one rotary lever is dimensioned in such a manner that it corresponds to a tautening distance and/or a spring travel of the pulling force element, so that at least one pulling force element is brought from an untautened into a tautened state during the movement within the play. In a starting position, i.e. a locked state of the locking device and an unactuated state of the operating unit, at least one of the pulling force elements, preferably both pulling force elements or all pulling force elements are slack, i.e. untensioned. Upon an actuating following the overcoming of the play of the operating unit and/or of the step-up transmission unit, the pulling force element or the pulling force elements is/are tautened, in particular tensioned, in an embodiment unstretched as yet. Preferably, the pulling force element following the overcoming of the respective play is tautened, without being elastically deformed in the process. Following the overcoming with further active force, the pulling force element is initially stretched or elongated within an elastic range until approximately a limit of the elastic range is reached. Following this, the full force transmission takes place in the elongated range. Upon force cancellation, a compressing thus takes place first followed by a slackening of the pulling force element.

Furthermore, with a motor vehicle seat, in particular with a motor vehicle seat having a backrest that is adjustable relative to a seat part, including at least one adjusting mechanism for adjusting the backrest, in an embodiment, the adjusting mechanism is configured as the adjusting device described above. In an embodiment, the motor vehicle seat is configured as an individual seat. In another embodiment, the motor vehicle seat is configured as a seat bench. In an embodiment, the seat bench is a split backrest, which can be individually and/or jointly adjusted via an adjusting device described above. A part of the force transmission device that is close to the engagement fitting is formed on the motor vehicle seat. The part of the force transmission unit that is distant from the engagement fitting is arranged spaced from the motor vehicle seat, for example in a front region of the motor vehicle or in a door region.

Furthermore, in a motor vehicle, in particular a passenger motor vehicle, including at least one seat unit for a vehicle occupant, in an embodiment, the seat unit is configured as a motor vehicle seat described above. The motor vehicle is for example a sedan, van, coupe, off-road vehicle, (mini) bus or the like.

Yet in another embodiment, a method for adjusting a motor vehicle seat by an adjusting device having at least two locking devices, in particular for adjusting a backrest position of the motor vehicle seat by a discontinuous adjusting device having at least two locking devices is provided. The method includes moving an operating unit, wherein during the moving a play is overcome, as a result of which a pulling force element is tautened. Prior to the force transmission, a tautening of the pulling force element for the force transmission takes place. During the force transmission, the pulling force element is stretched within elastic limits. Upon a diminishing of the force action, a resetting of the step-up transmission device or of the operating unit takes place because of the elastic resetting force of the pulling force element, in particular of the spring steel wire of the control cable. In this way, an at least partially integrated resetting device is realised in the pulling force element. The resetting is supported through the lever arms and/or the deflection part, which realise a step-up transmission ratio that is favourable for the resetting. The deflection part in particular supports the elastic deformation of the spring steel wire.

### BRIEF DESCRIPTION OF THE DRAWINGS

The various embodiments will hereinafter be described in conjunction with the following drawing figures, wherein like numerals denote like elements, and wherein:

FIG. 1 schematically illustrates a partial exploded representation of a detail of an adjusting device in accordance with an exemplary embodiment;

FIG. 2a schematically illustrates the adjusting device with pulling force element in a first position in accordance with an exemplary embodiment;

FIG. 2b schematically illustrates the adjusting device with pulling force elements in a second position in accordance with an exemplary embodiment;

FIG. 3 is an enlarged detail view of the adjusting device in accordance with an exemplary embodiment;

FIG. 4 is a force diagram of the locking device of the adjusting device in accordance with an exemplary embodiment;

FIG. 5a illustrate the detail of the adjusting device according to FIG. 3 with a step-up transmission device with pulling force elements in a first position in accordance with an exemplary embodiment; and

FIG. 5b illustrates the detail of the adjusting device of FIG. 5a with a step-up transmission device without pulling force elements in a second position in accordance with an exemplary embodiment.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

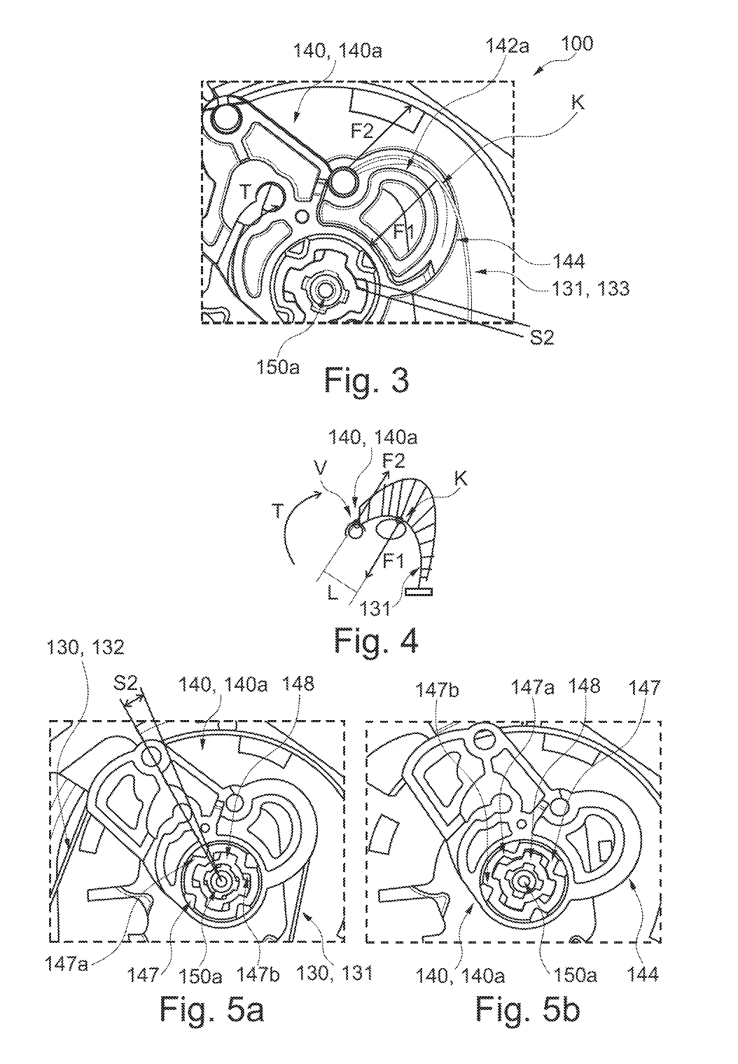

FIGS. 1 to 5b show an adjusting device 100 according to an exemplary embodiment in different views and different degrees of detail. FIG. 4 shows a force curve on certain components of the adjusting device 100.

The adjusting device 100 connects a backrest part 10 of a motor vehicle seat not shown in more detail here with a seat part 20 of the motor vehicle seat. Here, the backrest part 10 and the seat part 20 are connected to each other or relative to each other in a foldable manner via the adjusting device 100. The backrest part 10 and the seat part 20 are configured in two parts, wherein the backrest part 10 comprises two laterally spaced backrest part portions 11 and the seat part 20 to corresponding laterally spaced seat part portions 21, of which only one each is shown. In each case, one side of the adjusting device 100 is shown. In the embodiment shown here, the backrest part 10 additionally has a backrest adapter part 12 on each backrest part portion 11. The seat part 20 correspondingly comprises a seat adapter part 22 on each side portion. In the embodiment shown here, the seat adapter parts 22 are integrated in the side part portions 21 and thus integrated in the seat part 20, i.e. configured unitarily with these. On each side, the adjusting device 100 comprises a locking device 110.

The locking devices 110 each comprise two engagement fitting units, which when blocked through the locking devices 110 are engaged in each other and correspondingly are not engaged for an unlocking of the locking devices 110. A detailed description of the adjusting device 100 is made in the following in connection with the FIGS. 1 to 5b. Same or similar components are designated with same reference characters. A comprehensive description of components already described is omitted for the sake of better clarity.

FIG. 1 schematically shows a partial exploded representation of a detail of the adjusting device 100. In addition to the locking device 110, the adjusting device 100 comprises an operating unit 120. By way of the adjusting device 100, the backrest part 10 and the seat part 20 are connected to each other in a foldable manner. The seat part 20 and the backrest part 10 in this embodiment are configured as support structure of the vehicle seat which is not completely shown here, wherein in FIG. 1 only the components that are substantial to the immediate understanding of the embodiments are shown.

FIG. 1 shows one of the two locking devices 110 which are laterally spaced from each other. In an embodiment, in order to jointly actuate the two laterally spaced locking devices 110 via the joint actuating unit or operating unit 120 and thus actuate the entire adjusting device 100 via the joint operating unit 120, the two locking devices 110 are coupled to each other. Here, the locking devices 110 are connected in series. This means that the locking devices 110 are coupled to each other via a pulling force element 130, which in this case is configured as control cable 131.

In an embodiment, the shown locking device 110 is coupled to the operating unit 120. Coupling the operating unit 120 to the locking device 110 in this case is likewise effected via a pulling force element 130, which in this case is likewise designed as control cable 132.

In another embodiment, for actuating the locking devices 110, a step-up transmission device 140 configured as lever unit 140a is provided on the locking device 110. The lever unit 140a is arranged on a rotation axis 150a of the locking device 110. Here, the lever unit 140a is connected to the rotation axis 150a in a rotationally fixed manner. When the lever unit 140a is now rotated, the corresponding rotation axis 150a is likewise rotated with the lever unit, as a result of which the relevant locking device 110 is unlocked or blocked. Here, the respective engagement fitting of the locking device 110 preferably has a progressive force-distance characteristic.

The lever unit 140a comprises at least one lever arm 142a, via which a force step-up transmission can be realized, in one embodiment. Through the lever unit 140a acting as a (force) step-up transmission unit and simultaneously as a force transmission unit, any force-distance characteristic can be adjusted on the respective locking device 110. According to FIG. 1, the shown lever unit 140a of the locking device 110 is connected to the laterally spaced locking device 110 which is not shown here via the control cable 131, so that a movement of the lever unit 140a is transmitted to the lever unit which is not shown here. The lever unit 140a is furthermore connected to a further lever unit 140c of the operating unit 120 via the control cable 132. The lever unit 140c, like the lever unit 140a, is configured as rotatable lever unit 140c and in this case configured in particular as driver for an operating lever of the operating unit 120 which is not shown.

In an embodiment, the third lever unit 140c is rotatable about a rotation axis 150c spaced from the rotation axis 150a. The rotation axis 150c is formed on the lateral part 20. The further lever unit 140c sits on the rotation axis 150c in a rotationally fixed manner. By way of the control cable 132, the operating unit 120 can be arranged at any point on the seat part 20 via the rotation axis 150c. Preferably, the operating unit 120 is arranged on the motor vehicle seat. By actuating the operating unit 120, the lever unit 140c is turned. The movement or the rotational force is transmitted via the control cable 132 to the lever unit 140a and from there to the adjacent lever unit via the control cable 131. In order to move the respective lever units 140a, 140c back into their starting position following actuation, a resetting device 170 is provided. The resetting device 170 is partially configured integrated in at least one of the pulling force elements 130, more precisely in at least one of the control cables 131, 132. To this end, the respective control cable 131, 132 comprises at least one portion 133 that is elastic in a pulling direction. Preferably, the respective control cable 131, 132 comprises an elastic material, in particular spring steel. The latter is elastically deformable in a predetermined range or a portion 133. Accordingly, the spring steel has a spring travel which is employed for a resetting. Here, both control cables 131, 132 have an elastically deformable range 133, which ensures the resetting function. The control cable 132 connects the lever unit 140a with the lever unit 140c. The control cable 131 connects the lever unit 140a with the lever unit of the adjacent locking device which is not shown here. In this way, the control cables 131, 132 act on the step-up transmission unit 140 in different directions of rotation.

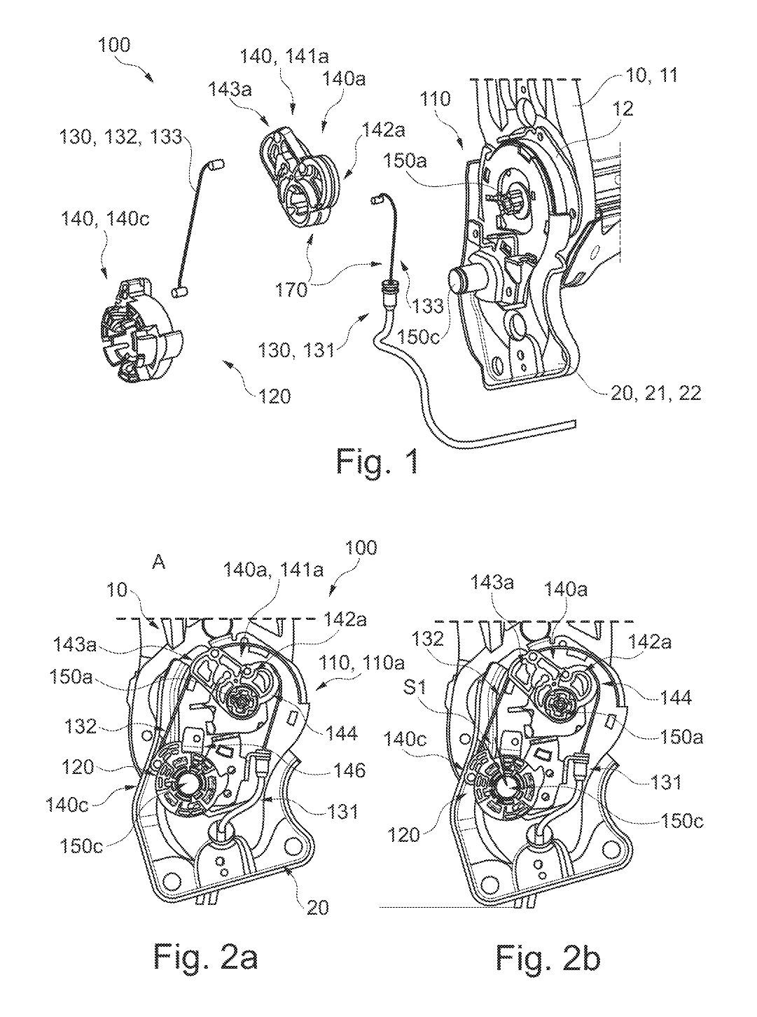

FIG. 2a schematically shows the adjusting device 100, more precisely a detail, with the pulling force elements 130 in a first position. FIG. 2b schematically shows the adjusting device 100 with the pulling force elements 130 in a second position.

On the shown side of the adjusting device 100, the lever unit 140a is configured as a rotary lever 141a. The rotary lever 141a is arranged on the rotation axis 150a of the locking device 110a in a rotationally fixed manner. A lever arm 142a and a lever arm 143a radially project towards the outside. The control cable 131 is fastened to the lever arm 142a. The control cable 132 is fastened to the lever arm 143a. Depending on the position of the lever arm 143a, the latter transmits a torque to the rotation axis 150a via the force introduced from the control cable 132. Stepped up by the lever arm 142a, the torque is passed on to the adjacent locking device 110 via the control cable 131. The lever arm 142a is designed with a deflection part 144, about which runs the control cable 132 having its surface. From the lever arm 143a, the control cable 131 runs to the lever unit 140c of the operating unit 120 configured as a driver for the operating lever. Both control cables 131, 132 are slack in the shown embodiment, i.e. not tensioned. The lever unit 140c rests against a stop 146, so that a rotation in the direction of the stop 146 is limited.

In an embodiment, as is shown in FIG. 2b, the lever unit 140c is seated on the rotation axis 150c with a circumferential play 51. Upon an actuation of the operating unit 120, the lever unit 140c is moved by the play S designed as angular play, wherein the control cable 132 is tensioned or tautened. Following a tautening, the force or the travel of the lever unit 140c is transmitted to the lever unit 140a by the control cable 132. As is evident in more detail in FIG. 3, the lever unit 140c is likewise seated on the rotation axis 150a with a play S2.

FIG. 3 schematically shows an enlarged detail of the adjusting device 100, in which the play-affected seat of the lever unit 140a is noticeable. Additionally, acting forces F1 and F2 as well as a torque D are shown. Upon a force action through the control cable 131, the control cable 131 in the region of the lever arm 142a hugs its surface or the deflection part 144. Here, on the one hand, the resultant force F1 acts at the contact point K for example as a component of a frictional force. On the other hand, the pulling force F2 transmitted by the control cable 131 acts on the connecting point V with the step-up transmission unit 140. Through the spacing of the connecting point V or the contact point K from the rotation axis 150 or from each other, the drawn-in torque T results from this. A corresponding force diagram is schematically shown in FIG. 4.

FIG. 4 schematically shows a force diagram of the locking device 110. Shown are the control cable 131 and the step-up transmission unit 140 as well as the contact point K and the connecting point V. The acting forces F1 and F2 are spaced from each other by the dimension L, as a result of which the torque T acts from the force differential F1-F2 or delta Fx1. The amount of the forces is schematically drawn in over the curve of the control cable 131. Here, the force curve changes depending on the rotation of the lever unit 140a.

FIG. 5a schematically shows the detail according to FIG. 3 with the step-up transmission device 140 with pulling force elements 130 in a first position and FIG. 5b schematically shows the detail according to FIG. 5a with a step-up transmission device without pulling force elements 130 in a second position. By means of these Figures, the mode of operation of the resetting device 170 is clearly evident. The lever unit 140c is seated on the rotation axis 150c with or without play as one in circumferential direction. Here, a lever arm of the lever unit 140c rests against the stop 146. The control cable 132 is slack or saggy slightly. The control cable 131 likewise saggy. The lever unit 140a is seated on the rotation axis 150a with a play S2 in circumferential direction. Here, the control cable 131 surrounds the deflection part 144. When the lever unit 140c is rotated, the control cable 132 is tautened or tensioned and a force is transmitted to the lever unit 140a. The latter is likewise rotated—in this case about the rotation axis 150a, wherein the play S2 is overcome. In the process, the control cable 131 is tensioned. If a further force is introduced, this force is further transmitted to the control cable 131. The latter is elastically stretched in a predetermined range and the force transmitted.

In the FIGS. 5a and 5b it is clearly evident how the lever unit 140 is seated on the rotation axis 150a with the play S2. In an embodiment, the lever unit 140a comprises a kind of toothings 147, which engages with play in a corresponding toothing 148, which is formed on the rotation axis 150a. In FIG. 5a, the toothing 148 bears against flanks 147a of a first side of the toothing 147. In FIG. 5b, the toothing 148 bears against the flanks 147b located opposite the flanks 147a.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. An adjusting device for adjusting a motor vehicle seat, the adjusting device comprising:
a locking device comprises a step-up transmission device;
a pulling force element configured for actuation and coupled to the step-up transmission device;
a resetting device configured to reset the step-up transmission device into a starting state, wherein the resetting device is at least partially integrated in the pulling force element.

2. The adjusting device according to claim 1, wherein the adjusting device is a discontinuous adjusting device for adjusting a backrest position of the motor vehicle seat.

3. The adjusting device according to claim 1, wherein the pulling force element at least partially comprises an elastic portion that is elastic in a pulling direction.

4. The adjusting device according to claim 3, wherein the elastic portion is formed from an elastic material.

5. The adjusting device according to claim 4, wherein the elastic portion is formed from spring steel.

6. The adjusting device according to claim 1, wherein the resetting device comprises a deflection part in a connecting region of the pulling force element with the step-up transmission device, along which the pulling force element runs at least partially.

7. The adjusting device according to claim 1, wherein the step-up transmission device is a rotary lever configured to be rotated about a rotation axis.

8. The adjusting device according to claim 7, wherein the rotary lever is seated with play on the rotation axis in a play-affected manner.

9. The adjusting device according to claim 8, wherein the play of the rotary lever is dimensioned such that this corresponds to a tautening distance of the pulling force element, so that the pulling force element is brought from an untautened into a tautened state during movement within the play.

10. The adjusting device according to claim 7, wherein on the rotary lever of the step-up transmission device, two pulling force elements acting in different directions of rotation are arranged.

11. The adjusting device according to claim 1, further comprising an operating unit that is arranged spaced from the step-up transmission device.

12. The adjusting device according to claim 11, wherein the operating unit is a rotary lever configured to be rotated about a rotation axis.

13. The adjusting device according to claim 1, wherein a connecting point of the pulling force element with the step-up transmission device is spaced from a rotation axis at an end of a deflection device, so that a torque results on a contact point of the pulling force element and the deflection device.

14. A motor vehicle seat having an adjusting device comprising:
a locking device comprising a step-up transmission unit;
a pulling force element configured for actuation and coupled to the step-up transmission unit; and
a resetting device configured to reset the step-up transmission unit into a starting state, wherein the resetting device is at least partially integrated in the pulling force element.

15. The motor vehicle seat according to claim 14, wherein the motor vehicle seat has a backrest that can be adjusted relative to a seat part.

16. A motor vehicle having a seat unit for a vehicle occupant, wherein the seat unit is configured as motor vehicle seat with an adjusting device comprising:
a locking device comprising a step-up transmission unit;
a pulling force element configured for actuation and coupled to the step-up transmission unit; and
a resetting device configured to reset the step-up transmission unit into a starting state, wherein the resetting device is at least partially integrated in the pulling force element.

17. The motor vehicle according to claim 16, wherein the motor vehicle is a passenger motor vehicle.

18. A method for adjusting a motor vehicle seat by means of an adjusting device having at least two locking devices, the method comprising the steps of:
moving an operating unit of the adjusting device;
during the moving, overcoming a play in a pulling force element coupled to the operating unit; and
tautening the pulling force element.

19. The method according to claim 18, wherein the adjusting device is a discontinuous adjusting device and the method results in the adjusting of a backrest position of the motor vehicle seat.
